(19) United States
(12) Patent Application Publication
(10) Pub. No.: US 2011/0253236 A1
(43) Pub. Date: Oct. 20, 2011

(54) NOVEL ELECTROMAGNETIC COUPLING JET APPARATUS

(76) Inventors: Kevin Le, Richland Hill, TX (US); Thanh Le, Grand Praire, TX (US)

(21) Appl. No.: 12/405,938

(22) Filed: Mar. 17, 2009

(51) Int. Cl. F04F 5/02; B23P 11/00; F04B 49/06

(52) U.S. Cl. 137/565.22; 417/45; 29/525.02; 417/151

(57) ABSTRACT

A massage jet pump may include a motor to rotate a first shaft, a first magnetic pole array may be adapted to be rotated by the first shaft, a second magnetic pole array may be magnetically coupled to the first magnetic pole array and may rotate in accordance with the first magnetic pole array, an impeller may pump the fluid in accordance with the rotation of the second magnetic pole array. The pump may include a mounting housing for pump mounting and prevent water leaking to the motor, a jet assembly to pump the water into dual jet streams, and an electronic sensor circuit to detect the presence of the jet assembly and shut down the motor when the jet assembly is removed from the pump or water level in the basin is low. The jet assembly may include a back cover, a fixed shaft, an impeller, a second magnet plate, and a front cover. The front cover of the jet assembly includes two output ports which guide the water jet streams in parallel or 45 degrees with respect to the axis of the fixed shaft. The jet assembly circulates the water by adapting the centrifugal concept.

### FIELD OF THE INVENTION

The present invention relates to a spa device. In particular, the present invention relates to a spa apparatus for use in activities employing a massage jet pump, such as in pedicures or other applications.

### BACKGROUND OF THE INVENTION

It is generally known to provide for a spa device, such as health spas, whirlpools, jet stream exercisers, foot spas, etc. Such known spa devices are typically used in commercial and recreational settings for hydrotherapy, massage, stimulation, pedicure, and bathing purposes. However, such spa devices typically include a motor in order to drive a pump. The shaft of the motor may be used to directly mount the impeller which may contact the water. Since the motor may not operate wet, a seal or a series of seals may be required to prevent water from entering the motor. The seals will wear to the point where water will enter the motor and consequently, the entering water may cause the motor to burn out. At this point, the motor assembly may be replaced in order to continue operation. This is expensive and may take several hours in which to perform.

It is generally known to provide for a spa device, such as health spas, whirlpools, jet stream exercisers, foot spas, etc. Such known spa devices are typically used in commercial and recreational settings for hydrotherapy, massage, stimulation, pedicure, and bathing purposes. However, such spa devices have several disadvantages including being difficult to thoroughly clean, requiring complicated maintenance schedules.

Several patents exist which describe spa related items and a brief description of a portion of these patents are found here in.

U.S. Pat. No. 7,168,107 discloses a spa apparatus and method for cleaning the same are disclosed. The spa apparatus includes a basin for retaining fluid, a removable foot rest plate positioned within the basin, an impeller coupled to the basin, and a motor drivably coupled to the impeller.

GB 2156218A describes a footbath which is in addition provided with various massaging means. In particular a vibrator is provided in order to have a massaging effect on the calf of a user, while massaging projections act on the soles of the feet. A vibrator is provided so that the massaging projections exert a massaging function. U.S. Pat. No. 4,569,337 discloses a massaging apparatus for the feet which is reversible between a dry condition in which it simply acts as a massager and a wet condition in which it acts as a footbath. A vibrator for effecting the massaging action is referred to, but is not described in any detail. U.S. Pat. No. 4,523,580 discloses a footbath where the foot supports within the footbath are reciprocated to achieve a massaging effect. U.S. Pat. No. 4,513,735 describes a footbath where foot supports are provided with protuberances, and in combination with a vibrating motor assembly and a vibrating plate these protuberances will carry out a massaging action. U.S. Pat. No. 7,393,188 discloses a whirlpool magnetic fluid pump assembly to be used in combination with a container having a wall. The pump assembly comprises a first casing disposed outside the container, and a second casing disposed inside the container. The pump uses two magnetic discs to provide the coupling between the first and second casing. Water turbulence is generated by an impeller on the second casing side. No axial flow water jet stream is produced, which is not suitable for hydromassaging pump in pedicures or other applications.

### SUMMARY

A massage jet pump may include a motor to rotate a first shaft, an magnetic pole array may be adapted to be rotated by the first shaft, a second magnetic pole array may be magnetically coupled to the first array and may rotate in accordance with the first array, a mounting housing for tub mounting and keep the distance between two magnetic pole arrays fixed, a jet assembly may pump the fluid into dual jet streams, and an electronic sensor circuit to detect the presence of the jet assembly and control power and startup speed of the motor.

The jet assembly may include a back cover, a fixed shaft mounted on the back cover, an impeller bonded to the second magnetic pole array, and a front cover.

The front cover may include an output port for the water discharging, and an input port for water in taking.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the pump of the present invention;

FIG. 2 illustrates a perspective view of the pedicure spa and jet pump of the present invention;

FIG. 3 illustrates a perspective view of the front cover, in which guides the water into two parallel jet streams.

FIG. 4 illustrates a perspective view of another front cover, in which guides the water into two jet streams that are 45 degrees with respect to the shaft axis.

FIG. 5 illustrates a perspective view of the jet pump;

FIG. 6 illustrates a perspective view of the second magnetic pole array and ended with the impeller for centrifugal jet pump;

FIG. 7 illustrates a perspective view of the jet assembly;

### DETAILED DESCRIPTION

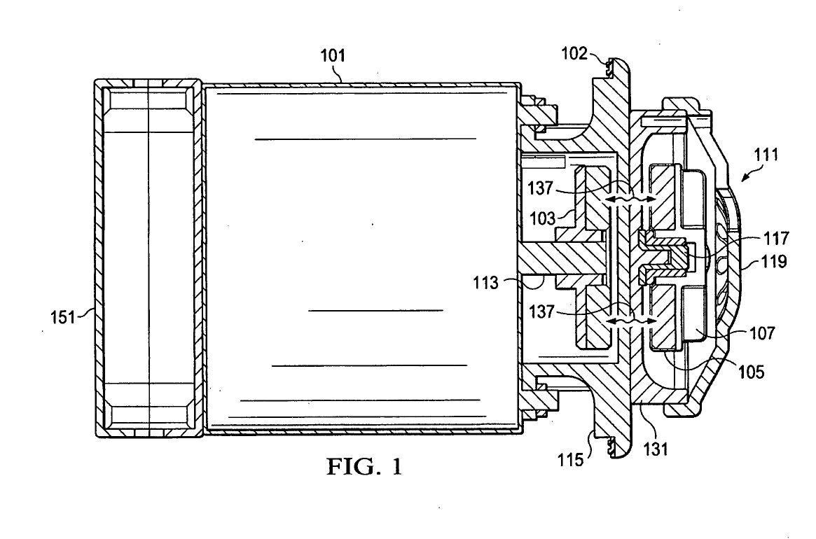

FIG. 1 illustrates a cross-sectional view of the magnetically coupled pedicure spa jet pump 100 of the present invention. The spa jet pump 100 may include a motor member 101 which may be connected to a first shaft member 113 which may be connected to a first magnetic pole array 103 which may be formed from magnetic material and may be magnetized in order to generate a magnetic field. The motor member 101 may be electrically connected to an electrical source (not shown) and may be activated by the electrical power from the electrical source and may rotate the first shaft member 113. The first shaft member 113 may be rotated by the activated motor member 101 and may rotate the first magnet array 103 which may cause the magnetic field 137 to move or fluctuate in accordance with the rotation of the first magnetic pole array 103. The first magnetic pole array 103 may be enclosed with a mounting housing member 115 and gasket 102 which may be referred to as a mounting housing 115 to prevent fluid from contaminating the motor member 101.

The first magnetic pole array 103 may generate a fluctuating magnetic field so that when the second magnetic pole array 105 is placed in relative close proximity to the first magnetic pole array member 103, the fluctuating magnetic field 137 may cooperate with the second magnetic pole array 105 in order to rotate the second magnetic pole array 105. The second magnetic pole array 105 may be formed from magnetic material so that the fluctuating magnetic field 137 may cooperate with the second magnetic pole array 105. The second magnetic pole array 105 may be centrally positioned in the jet assembly 109 which may include a back cover 131 and a front cover 119 and may rotate on a second shaft 117 and may be rotatably connected to an impeller member 107. The impeller member 107 may be connected to an input port to allow fluid to flow into the impeller member 107 and may be connected to an output port 111 to allow the fluid to be pumped exterior to the jet pump 100. The impeller member 107 may rotate in cooperation with the second magnetic pole array 105 and may be integral or formed separate with the second magnetic pole array 105. Electronic sensor 151 may provide a signal to indicate the presence of the jet assembly 109 and may automatically shut down the motor when the jet assembly is removed from the pump or no water in the basin. Electronic sensor 151 prevents the situation in which the motor runs without a load.

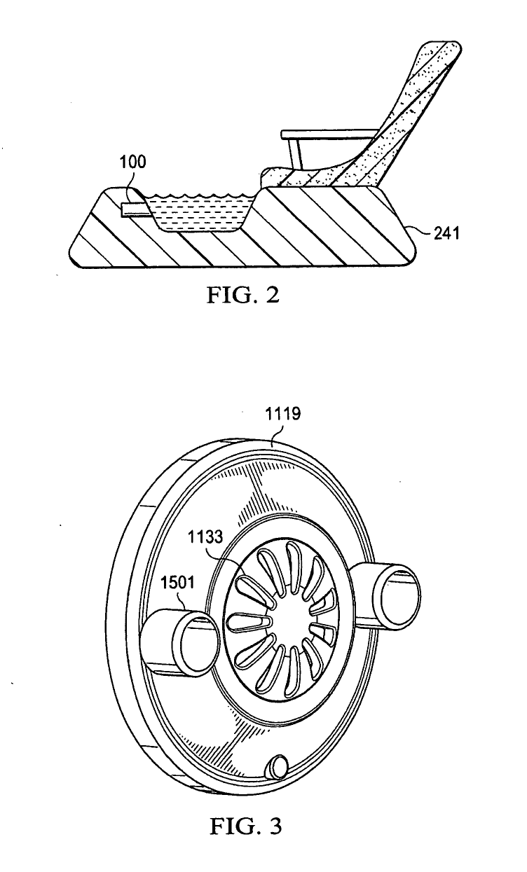

FIG. 2 illustrates the basin 241 of the pedicure spa, and the pump 100 connected to the basin 241.

FIG. 3 illustrates the exterior of the front cover 1119 and illustrates input ports 1133 being substantially centrally located in the front cover 1119. FIG. 3 illustrates an output port 1501 (a second angled output port may be included which opposes the angled output port 1501) which may be angled at 90° to the face in order to output a fluid in two parallel jet streams.

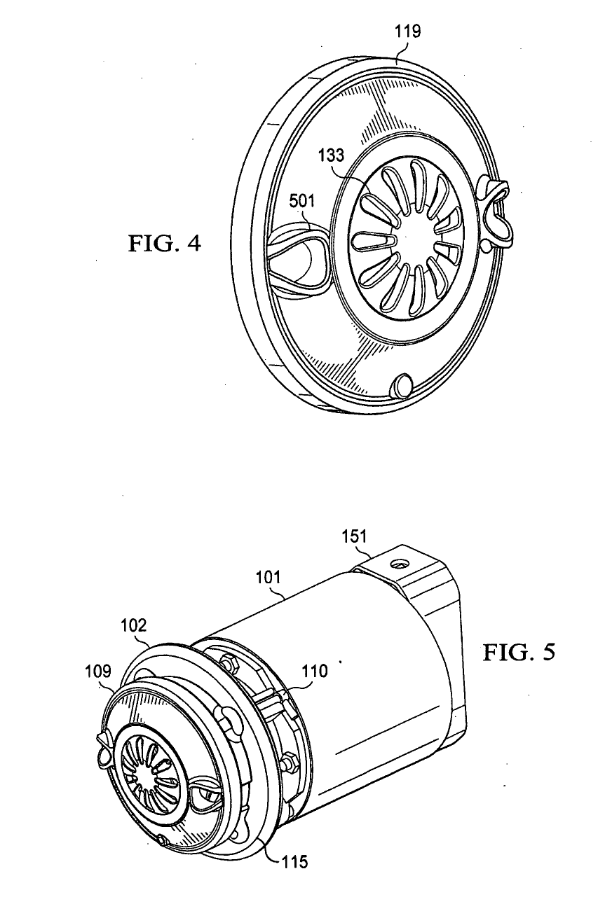

FIG. 4 illustrates the exterior of another front cover 119 and illustrates input ports 133 being substantially centrally located in the front cover 119.

FIG. 4 illustrates an angled output port 501 (a second angled output port may be included which opposes the angled output port 501) which may be angled in order to output a fluid in a jet stream at 45 degrees with respect to the shaft 117.

FIG. 5 illustrates the complete jet pump 100 which includes; a jet assembly 109 to pump the water into dual jet stream, a seal gasket 102 to prevent water leaking to the motor, a mounting housing 115 to allow for pedicure spa basin mounting and to cover the first magnetic pole array, a set of four of screws with wings nut 110 to support the pump mounting, a motor 100 to magnetically drive the jet assembly, and an electronics sensor system 151 for jet pump control.

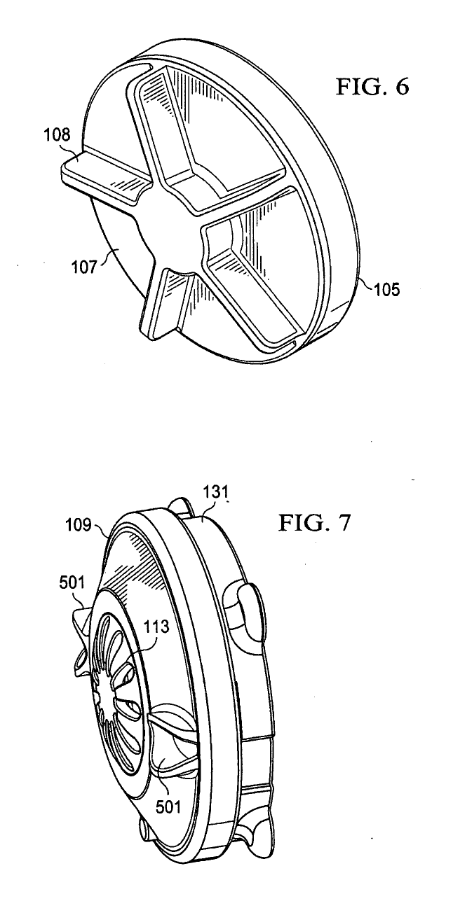

FIG. 6 illustrates the second magnetic pole array member 105 which is coupled to the centrifugal impeller member 107. The impeller member 107 may include a circular array of arm member 108 to centrifuge and pressurize the fluid inside the jet assembly housing and create the powerful jet streams at the output ports 501.

FIG. 7 illustrates the jet assembly 109 which is driven by the motor 101 and the first magnetic pole array 103. The housing of jet assembly 109 include a front cover 119, a back cover 131. The front cover 119 includes an input port 113 and two output ports 501.

The jet streams of fluid may flow substantially in a longitudinal direction with respect to the pump 100 or the jet streams of the fluid may flow substantially at an angle with respect to the longitudinal direction.

A front cover 119 may have input ports around the outer periphery of the front cover 119 which may be apertures or the input ports may be a gap between the front cover 119 and the back cover 131. The input ports may also be a gap between the front cover 119 and the mounting housing 115.

In order to mount the pump 100, a hole may be drilled in the basin 241. The pump 100 may be placed within the hole which may have been drilled from the interior of the basin 241. The mounting screws may be tightened. While the mounting screws are being tightened, wing nuts 110 located in exterior to the basin wall may be extended in order for the mounting screws to be tightened. The mounting housing 115 may include a rubber gasket 102 which may be tightened with screws and wing nuts 110.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A jet pump comprising:
a drive motor,
a mounting housing to mount the motor to the pedicure spa basin;
a magnetically driven jet assembly to magnetically drive a jet impeller, and
an electronic sensor circuitry to control the startup speed and power to the motor.

2) The jet pump as in claim 1, wherein the water discharged from the pump are jet streams for hydro-massaging.

3) The jet pump as in claim 1, wherein jet assembly comprises a back cover, a magnet plate, an impeller, a shaft, and a front cover.

4) The jet assembly as in claim 3, wherein the magnet plate and the impeller are bonded back-to-back.

5) The jet assembly as in claim 3, wherein the front cover is detachable from the jet assembly.

6) The jet assembly as in claim 3, wherein the shaft is integrally mounted on the back cover to provides rotation axis for the magnet plate and impeller.

7) The jet assembly as in claim 3, wherein the impeller is located inside the jet assembly and between the front cover and back cover.

8) The jet pump as in claim 1, wherein the motor rotation torque/power is coupled to the jet assembly by coupling magnetic field rotation.

9) The jet pump as in claim 1, wherein the coupling magnetic field is generated by two planar magnetic plates.

10) The jet pump as in claim 1, wherein the jet assembly can be detached from the pump by hand for cleaning and inspection.

11) The jet pump as in claim 1, wherein the jet assembly and the motor are isolated by the wall of the pump mounting housing which substantially prevents the water from entering into the motor.

12) The jet pump as in claim 1, wherein the electronics sensor circuitry detects the presence of the jet assembly and automatically shuts down the motor when the jet assembly is removed from the pump or water level in the basin is low.

13) The jet pump as in claim 1, wherein the water is sealed by rubber gasket located between the mounting housing and the tub wall.

14) The jet pump as in claim 1, wherein the water is pumped by the centrifugal concept to generate the powerful output jet streams.

15) A method for jet pump installation from the front of a tub, comprising the steps of:
drilling a hole in the tub wall
inserting the pump though the hole in tub wall from inside of the tub
tightening screws, the wing-nuts located behind the tub wall will cooperate with the screws to extend out and allows the screws to be tightened from the inside of the tub

16) The method of circulating the water in the tub comprises the steps of:
removing water from the tub and discharging the water into the tub by jet streams for massaging;
inputting water into the jet assembly via a plurality of ports on the jet assembly front face;
discharging the water through two ports on the jet assembly housing that direct the water streams in parallel or along an axis about 45 degrees with respect to axis of the shaft.

17) A jet pump for pumping the fluid, comprising:
a motor to rotate a first shaft;
a first magnetic pole array being adapted to be rotated by the first shaft;
a second magnetic pole array being magnetically coupled to the first magnetic pole array and to rotate in accordance with the first magnetic pole array;
a mounting housing to support the pedicure spa mounting
a jet assembly to pump the fluid into dual jet streams

18) The jet pump for pumping the fluid as in claim 16, wherein the magnetic pole arrays may be arranged in circular alternating polarities to increase the rotational torque coupling.

19) The jet pump for pumping the fluid as in claim 16, wherein the first and second magnetic pole array may be identical.

20) The jet pump for pumping the fluid as in claim 16, wherein the mounting housing, and the jet assembly housing are made of a nonconductive material.
